(19) United States
(12) Patent Application Publication
(10) Pub. No.: US 2008/0240053 A1
(43) Pub. Date: Oct. 2, 2008

(54) Quality of service (QoS) negotiation between network nodes in a Mobile IP network

(76) Inventors: Anand K. Oswal, Sunnyvale, CA (US); Ramanathan Lakshmikanthan, Milpitas, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/729,289

(22) Filed: Mar. 27, 2007

(51) Int. Cl. H04Q 7/24

(52) U.S. Cl. 370/338

(57) ABSTRACT

Techniques for negotiating QoS between a foreign agent and a home agent of a Mobile IP network are described herein. According to one embodiment, quality of service (QoS) parameters are extracted from a registration reply message received from a home agent of a home network in response to a registration request message originated from a mobile node coupled to a foreign network. Thereafter, network traffics between the mobile node of the foreign network and the home agent of the home network associated with the mobile node are routed according to at least a portion of the QoS parameters. Other methods and apparatuses are also described.

### FIELD OF THE INVENTION

The present invention relates generally to network communications. More particularly, this invention relates to QoS negotiation between a foreign agent and a home agent of a Mobile IP network.

### BACKGROUND

Mobile IP is a protocol which allows laptop computers or other mobile computer units (referred to as mobile nodes herein) to roam between various sub-networks at various locations, while maintaining Internet and/or WAN connectivity. In a typical Mobile IP network, when a mobile node roams from one foreign network to another foreign network, the mobile node has to send a registration request according to a Mobile IP protocol to a foreign agent associated with the foreign network to establish a communication session with a home agent associated with the mobile node.

Typically, quality of service (QoS) associated with a mobile node is negotiated by a radio controller/IP Gateway with an authentication facility such as AAA (authentication, authority, and accounting) server when the mobile node enters a radio access network (RAN). Such QoS parameters are applied to all communications (rather than per communication session basis) associated with the mobile node and the foreign agents are unaware of the QoS parameters unless the Radio Controller and the Foreign communicate or they co-exist.

### SUMMARY OF THE DESCRIPTION

Techniques for negotiating QoS between a foreign agent and a home agent of a Mobile IP network are described herein. According to one embodiment, quality of service (QoS) parameters are extracted from a registration reply message received from a home agent of a home network in response to a registration request message originated from a mobile node coupled to a foreign network. Thereafter, network traffics between the mobile node of the foreign network and the home agent of the home network associated with the mobile node are routed according to at least a portion of the QoS parameters.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating an example of a Mobile IP network configuration which may be used with one embodiment of the invention.

FIG. 2 is a block diagram illustrating an example of a network element according to one embodiment of the invention.

FIG. 3 is a flow diagram illustrating a process for negotiating QoS parameters according to one embodiment of the invention.

FIGS. 4A and 4B are block diagrams illustrating examples of registration request/reply messages which may be used with one embodiment of the invention.

FIG. 5 is a block diagram illustrating an example of a data structure for storing QoS parameters according to one embodiment of the invention.

### DETAILED DESCRIPTION

Techniques for negotiating QoS between a foreign agent and a home agent of a Mobile IP network are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments of the invention, QoS parameters are negotiated between a foreign agent and a home agent during a Mobile IP registration process. The QoS parameters are applied specifically to a subscriber session of a mobile node between a foreign agent and a home agent of the mobile node (e.g., per session basis). As a result, different QoS parameters may be applied based on a particular session and/or a particular foreign agent, or other circumstance factors.

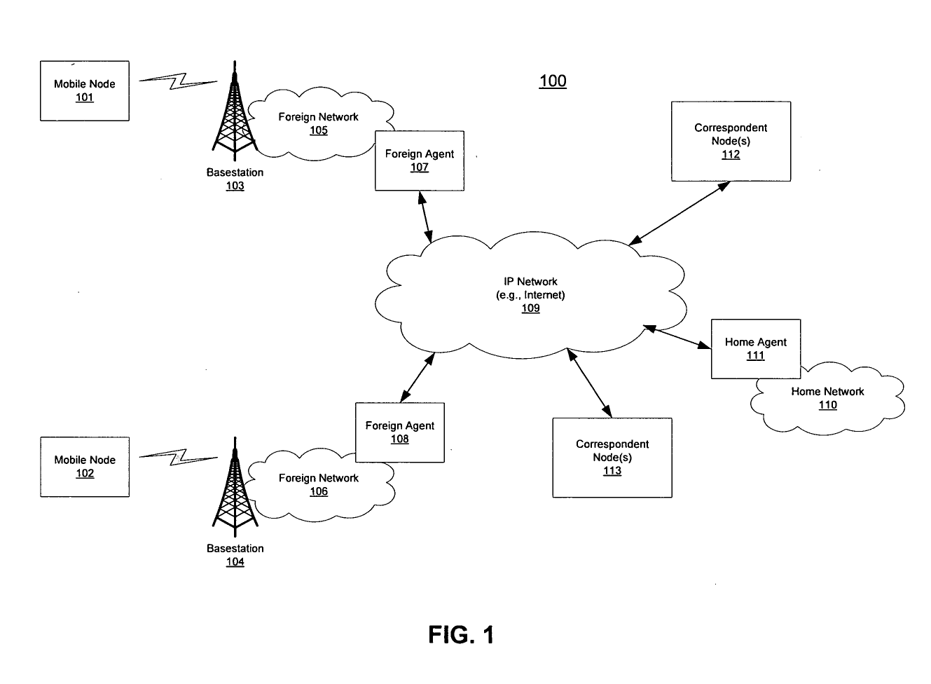

FIG. 1 is a block diagram illustrating an example of a Mobile IP network configuration which may be used with one embodiment of the invention. Referring to FIG. 1, network configuration 100 includes, but is not limited to, includes a network 109, which may be the Internet or WAN (wide area network) over which mobile nodes 101-102 can communicate remotely via mediation by their corresponding home agents (e.g., home agent 111) and foreign agents (e.g., foreign agents 107-108). Typically, the home agent and foreign agent are routers or other network connection devices performing appropriate Mobile IP functions as implemented by software, hardware, or a combination of both.

In Mobile IP, a foreign agent may be a router on a mobile node's visited network that provides routing services to the mobile node to which it is registered. The foreign agent delivers datagrams to the mobile node that was tunneled by the mobile node's home agent. For datagrams sent by a mobile node, the foreign agent can serve as a default router for registered mobile nodes and provide reverse tunneling if required. In Mobile IP, a home agent may be a router on a mobile node's home network that tunnels datagrams to the mobile node when it is away from the home location, and maintains current location information for the mobile node. For example, any one of foreign agents 107-108 and home agent 111 may be an L2TP (layer 2 tunneling protocol) access concentrator (LAC) or a BRAS (broadband remote aggregation server), such as, for example, a SmartEdge™ router available from Redback Networks of San Jose, Calif.

Mobile nodes 101-102 may include any device capable of coupling to a wireless network such as foreign networks 105-106. Such devices may include cellular phones, smart phones, pagers, radio frequency (RF) devices, infrared (IR) devices, integrated devices combining one or more of the preceding devices, etc. Mobile nodes 101-102 may also include other devices that have a wireless interface such as personal digital assistants (PDAs), handheld computing devices, personal computers, consumer electronics devices, etc.

A particular mobile node plugged into its home network segment connects with the internet through its designated home agent. When the mobile node roams, the mobile node communicates via the Internet through an available foreign agent. Presumably, there are many foreign agents available at geographically disparate locations to allow wide spread internet connection via the Mobile IP protocol. Note that it is also possible for the mobile node to register directly with its home agent.

For the purpose of illustration, it is assumed that mobile node 101 is associated with home network 110. Referring to FIG. 1, mobile node 101 normally resides on (or is “based at”) a network segment 110 (also referred to as a home network) which allows its network entities to communicate over the network 109 through home agent 111. Network 109 may include the Internet, WAN, or a backbone core network.

Now, suppose that mobile node 101 is removed from its home network 110 and roams to a remote network segment 105 (also referred to as a foreign network). Foreign network 105 may include various other nodes. The nodes on foreign network 105 communicate with network 109 through the corresponding foreign agent 107. Mobile node 101 may identify foreign agent 107 through various solicitations and advertisements which form part of the Mobile IP protocol. When mobile node 101 engages with network segment 105, foreign agent 107 relays a registration request to home agent 111. The home agent 111 and foreign agent 107 may then negotiate the conditions of the mobile node's attachment to foreign agent 107. For example, the attachment may be limited to a predetermined period of time, such as two hours. When the negotiation is successfully completed, home agent 111 updates an internal “mobility binding table” which specifies the care-of address or CoA (e.g., a collocated care-of address or the foreign agent's IP address) in association with the identity of mobile node 101. Further, the foreign agent 107 updates an internal “visitor table” which specifies the mobile node address, home agent address, etc. In effect, the mobile node's home base IP address (associated with network segment 110) has been shifted to the foreign agent's IP address (associated with network segment 105).

Now, suppose that mobile node 101 wishes to send a message to a correspondent node such as nodes 112-113 from its new location (e.g., within foreign network 105). An output message from the mobile node 101 is then packetized and forwarded through foreign agent 107 over the network 109 and to correspondent nodes 112-113 according to a standard internet protocol. If correspondent nodes 112-113 wish to send a message to mobile node 101, whether in reply to a message from the mobile node 101 or for any other reason, correspondent nodes 112-113 may address that message to the IP address of mobile node 101 on foreign network 105. The packets of that message are then forwarded over network 109 and to home agent 111.

From its mobility binding table, home agent 111 recognizes that mobile node 101 is no longer attached to network segment 110. Home agent 111 then encapsulates the packets from correspondent nodes 112-113 (which are addressed to mobile node 101 on network segment 110) according to a Mobile IP protocol and forwards these encapsulated packets to a “care of” address for mobile node 101. The care-of address may be, for example, the IP address of foreign agent 107. Foreign agent 107 then strips the encapsulation and forwards the message to mobile node 101 on network 105. The packet forwarding mechanism implemented by the home and foreign agents is often referred to as “tunneling.”

Similarly, mobile node 102 communicates with its home agent and other correspondent nodes of network 109 via basestation 104, foreign network 106, and foreign agent 108 in a similar manner described above.

During registration of a mobile node with its home agent, the identities of the sending party of the registration request (e.g., mobile node) and the sending party of the registration reply (e.g., home agent) are authenticated. During the registration process, a mobile-home authentication extension is typically appended to both the registration request and the registration reply. Upon receipt of the registration request by the home agent and the registration reply by the mobile node, the identity of the sending party is authenticated through the application of the mobile-home authentication extension.

According to one embodiment of the invention, each of the home agent 111 and foreign agent 107-108 may include a QoS unit that negotiates QoS parameters during the registration/authentication on behalf of a mobile node. The QoS parameters may be used in a communication session (e.g., subscriber session) by a foreign agent for the network traffics between the mobile node and other nodes (e.g., correspondent nodes) of network 109. As a result, a foreign agent is aware of the QoS parameters for a particular communication session initiated from the foreign agent on behalf of a mobile node.

For example, when mobile node 101 enters (via basestation 103) foreign network 105, which may be a radio access network, mobile node 101 sends a registration request according to a Mobile IP protocol to foreign agent 107. Foreign agent 107 may update its internal visitor table indicating that mobile node 101 is visiting network 105. Foreign agent 107 then relays the registration request to home agent 111 associated with mobile node 101. Upon successfully validating or authenticating mobile node 101 based on the registration request, home agent 111 responds with a registration reply message to foreign agent 107. In addition, according to one embodiment, home agent 111 may also embed certain QoS parameters in the registration reply message.

When foreign agent 107 receives the registration reply message from home agent 111, foreign agent 107 extracts the QoS parameters from the registration reply message and stores in an internal storage. Thereafter, at least a portion of the QoS parameters may be applied to a communication session between mobile node 101 and other nodes (e.g., correspondent nodes 112-113) via foreign agent 107. In this situation, the QoS may be maintained by foreign agent 107 according to at least some of the QoS parameters extracted from the registration reply message, while mobile node 101 is still coupled to foreign network 105.

When mobile node 101 roams from foreign network 105 to another foreign network 106, the mobile node may have to send another registration request to foreign agent 108 associated with the foreign network 106. Similar to foreign agent 107 described above, foreign agent 108 updates its internal visitor table and relays the registration request to home agent 111. In response to the registration request, upon successfully validate/authenticating the mobile node, home agent 111 responds with a registration reply message having certain QoS parameters embedded therein. When foreign agent 108 receives the registration reply message, foreign agent 108 extracts the QoS parameters and applies at least a portion of the extracted QoS parameters in a communication session associated with the mobile node, while the mobile node is coupled to foreign network 106.

Note that the QoS parameters extracted from the registration reply received by foreign agents 107 and 108 may be identical or different. As a result, foreign agents 107-108 are aware of the QoS parameters and the QoS parameters are applied to a specific communication session of the mobile node in a specific foreign network (e.g., networks 105-106). Therefore, the QoS parameters are applied per session basis. Other configurations may exist.

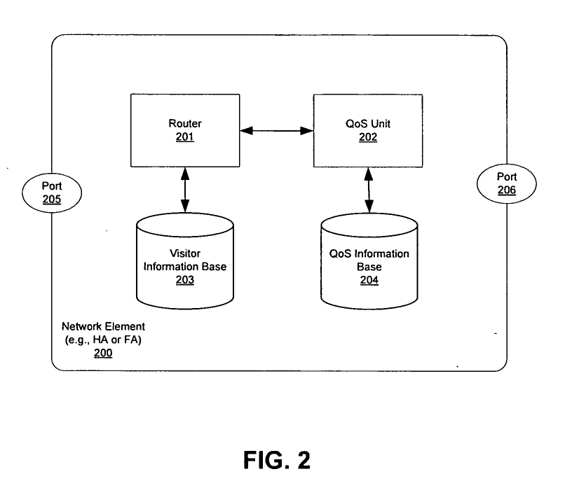

FIG. 2 is a block diagram illustrating an example of a network element according to one embodiment of the invention. For example, network element 200 may be implemented as part of a foreign agent or a home agent, similar to foreign agents 107-108 and home agent 111 of FIG. 1. Referring to FIG. 2, according to one embodiment, network element 200 includes, but is not limited to, a routing unit 201, a QoS unit 202, a visitor information base 203, and a QoS information base 204. Network element 200 further includes one or more ports or interfaces 205-206 for interfacing external network connections. Ports 205-206 may be considered as ingress ports or egress ports dependent upon directions of the network traffics. For example, for the purpose of illustration, port 205 may be coupled to mobile node 101 over foreign network 105 of FIG. 1 while port 206 may be coupled to network 109 of FIG. 1.

According to one embodiment, when a mobile node enters a foreign network associated with network element 200 (which is a foreign agent in this example), the mobile node sends a registration request to network element 200 according to the Mobile IP protocol. In response, routing unit 201 of network element 200 updates visitor information base 203 regarding a new mobile node visiting the associated foreign network and relays the registration request to a home agent (e.g., home agent 111 of FIG. 1) associated with the mobile node. Upon successfully validating/authenticating the mobile node, network element 200 receives a registration reply message from the home agent having QoS parameters embedded therein. In response to the registration reply message, QoS unit 202 extracts the QoS parameters from the registration reply message and stores the QoS parameters in QoS information base 204. Thereafter, the routing unit 201 may apply at least a portion of QoS parameters in a subsequent communication session between the mobile node and other nodes (e.g., correspondent nodes). Note that information bases 203-204 may be maintained locally or remotely. Also note that some of all of the components of network element 200 may be implemented in hardware, software, or a combination of both. Other configuration may exist.

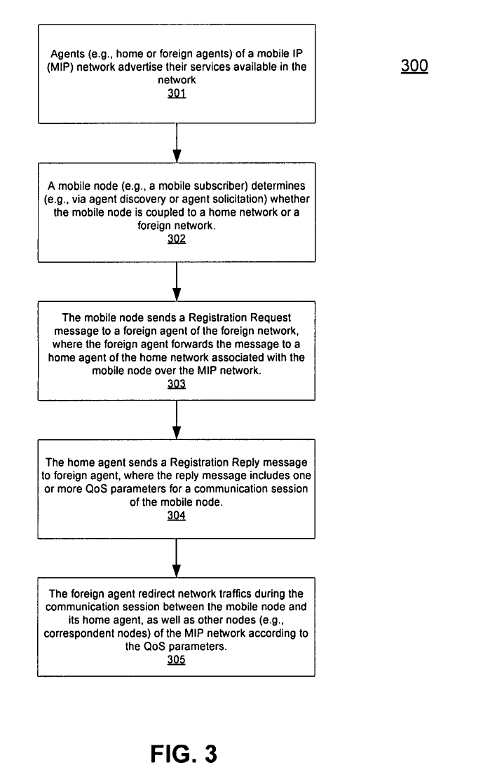

FIG. 3 is a flow diagram illustrating a process for negotiating QoS parameters according to one embodiment of the invention. Note that process 300 may be performed by processing logic which may include hardware, software, or a combination of both. For example, process 300 may be performed by a foreign agent and/or a home agent (e.g., network element 200 of FIG. 2). Referring to FIG. 3, initially, agents (e.g., home agents and/or foreign agents) of a Mobile IP network advertise their services available in the network. At block 302, a mobile node determines (e.g., via agent discovery or agent solicitation) whether the mobile node is coupled to a home network or a foreign network.

If it is determined that the mobile node is coupled to a foreign network, at block 303, the mobile node sends a registration request according to the Mobile IP protocol to a foreign agent associated with the foreign network. The foreign agent updates its internal visitor table regarding the mobile node entering the corresponding foreign network and the foreign agent forwards the registration request to a home agent associated with the mobile node. Upon successfully validating/authenticating the mobile node based on the registration request, at block 304, the home agent responds to the foreign agent with a registration reply message. In addition, the home agent embeds certain QoS parameters in the registration reply message for a communication session of the mobile node. When the foreign agent receives the registration reply message, at block 305, the foreign agent extracts the QoS parameters from the registration reply message and may store the QoS parameters in an internal storage. Thereafter, the foreign agent may apply at least a portion of the QoS parameters in a subsequent communication session between the mobile node and other nodes (e.g., home agent and other correspondent nodes) of the Mobile IP network. Other operations may also be performed.

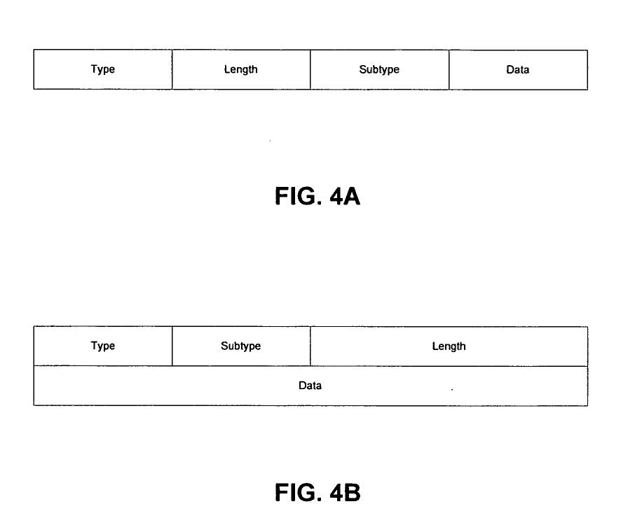

As described above, the QoS parameters may be embedded within a registration reply message by a home agent in response to a registration request message originated from a mobile node and forwarded by a foreign agent. The registration request and registration reply messages may be implemented in accordance with a Mobile IP protocol, such as, for example, those described in RFC-3344, entitled “IP Mobility Support for IPv4”. In one embodiment, such QoS parameters may be stored in a type-length-value (TLV) extension format for Mobile IP extension message, either in a short form as shown in FIG. 4A or a long form as shown in FIG. 4B.

Referring to FIGS. 4A and 4B, the “Type” field (e.g., 8 bits) may be used to describe a collection of extensions having a common data type. The “Subtype” field (e.g., 8 bits) may include a unique identifier given to each member in the aggregated type. The “Length” field (e.g., 8 bits for the short form and 16 bits for the long form) may be used to indicate the length (in bytes) of the “Data” field within this extension. The “Data” field (e.g., 8 bits for the short form and 32 bits for the long form) may be used to store the particular data associated with the subtype (specified by the “Subtype” field) of this extension. According to certain embodiments of the invention, a variety of QoS parameters may be stored or carried in these formats within a registration reply message.

In the fields of packet-switched networks and computer networking, the traffic engineering term quality of service refers to control mechanisms that can provide different priority to different users or data flows, or guarantee a certain level of performance to a data flow in accordance with requests from the application program. Quality of service guarantees are important if the network capacity is limited, especially for real-time streaming multimedia applications, for example voice over IP and IP-TV, since these often require fixed bit rate and may be delay sensitive.

A network or protocol that supports quality of service may agree on a traffic contract with the application software and reserve capacity in the network nodes during a session establishment phase. During the session it may monitor the achieved level of performance, for example the data rate and delay, and dynamically control scheduling priorities in the network nodes. It may release the reserved capacity during a tear down phase. A best-effort network does not support Quality of Service.

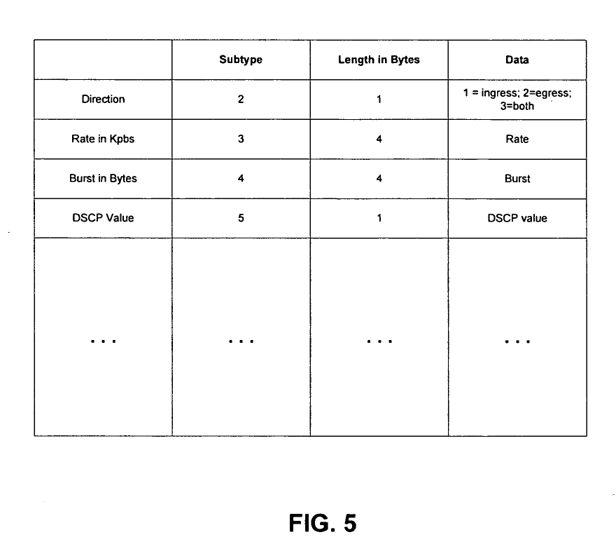

According to one embodiment of the invention, QoS parameters embedded within the registration request/reply messages may include a variety of QoS parameters, such as, for example, bit rate, burst rate, DSCP (differentiated service code point) values, as well as the network traffic direction in which these parameters are applied, as shown in FIG. 5. Dependent upon the direction specified in the data structure as shown in FIG. 5, ingress means on a foreign agent for traffic coming from a basestation while egress refers to traffic flowing from a foreign agent towards a basestation. In addition, the IP DSCP and internal queuing DSCP of a network element (e.g., router) may be marked by using t he DSCP value specified in the data structure as shown in FIG. 5. A DSCP value may be used to classify the packets into a class to help ensure end-to-end QoS. Packets marked with such may get appropriate queuing, such that different priorities of the network traffic may be differentiated amongst the mobile subscribers. Furthermore, a home agent can send multiple of these rate values or burst values according to RFC-2697 and/or RFC 2698. For example, for a single-rate-three-color marker, there could have one rate value, two burst values, and three mark values. Note that the QoS parameters listed in FIG. 5 are shown for the purpose of illustration only. More or fewer parameters and/or other formats may also be applied.

Thus, techniques for negotiating QoS between a foreign agent and a home agent of a Mobile IP network have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for routing network traffics, the method comprising:
extracting quality of service (QoS) parameters from a registration reply message received from a home agent of a home network in response to a registration request message originated from a mobile node coupled to a foreign network; and
routing network traffics between the mobile node of the foreign network and the home agent of the home network associated with the mobile node according to at least a portion of the QoS parameters.

2. The method of claim 1, wherein-the mobile node and the home agent are Mobile IP (MIP) compliant devices, and wherein the registration request message and registration reply message are transmitted according to a MIP compatible communication protocol.

3. The method of claim 2, wherein the QoS parameters are embedded within an extension field of the registration reply message compatible to the MIP compatible communication protocol.

4. The method of claim 1, further comprising establishing a communication session with the home agent of the home network, wherein the at least a portion of the QoS parameters are used specifically for the established communication session.

5. The method of claim 1, further comprising:
in response to the registration request message from the mobile node when the mobile node entering the foreign network, updating a visitor table regarding the mobile node and relaying the registration request message to the home agent;
in response to the registration reply message received from the home agent, associating the registration reply message with the mobile node based on the visitor table; and
storing the QoS parameters extracted from the registration reply message in a storage.

6. The method of claim 1, wherein the QoS parameters comprise a parameter at least one of a traffic direction associated with a particular QoS parameter, rate, burst, and a DSCP value.

7. A machine-readable medium having instruction,stored therein, which when executed by a processor, cause the processor to perform a method for routing network traffics, the method comprising:
extracting quality of service (QoS) parameters from a registration reply message received from a home agent of a home network in response to a registration request message originated from a mobile node coupled to a foreign network; and
routing network traffics between the mobile node of the foreign network and the home agent of the home network associated with the mobile node according to at least a portion of the QoS parameters.

8. The machine-readable medium of claim 7, wherein the mobile node and the home agent are Mobile IP (MIP) compliant devices, and wherein the registration request message and registration reply message are transmitted according to a MIP compatible communication protocol.

9. The machine-readable medium of claim 8, wherein the QoS parameters are embedded within an extension field of the registration reply message compatible to the MIP compatible communication protocol.

10. The machine-readable medium of claim 7, wherein the method further comprises establishing a communication session with the home agent of the home network, wherein the at least a portion of the QoS parameters are used specifically for the established communication session.

11. The machine-readable medium of claim 7, wherein the method further comprises:
in response to the registration request message from the mobile node when the mobile node entering the foreign network, updating a visitor table regarding the mobile node and relaying the registration request message to the home agent;
in response to the registration reply message received from the home agent, associating the registration reply message with the mobile node based on the visitor table; and
storing the QoS parameters extracted from the registration reply message in a storage.

12. The machine-readable medium of claim 7, wherein the QoS parameters comprise a parameter at least one of a traffic direction associated with a particular QoS parameter, rate, burst, and a DSCP value.

13. A network element, comprising:
a quality of service (QoS) unit to extract QoS parameters from a registration reply message received from a home agent of a home network in response to a registration request message originated from a mobile node coupled to a foreign network; and
a routing unit coupled to route network traffics between the mobile node of the foreign network and the home agent of the home network associated with the mobile node according to at least a portion of the QoS parameters.

14. The network element of claim 13, wherein the network element is a foreign agent interfacing the foreign network with the home network.

15. The network element of claim 14, wherein the mobile node and the home agent are Mobile IP (MIP) compliant devices, and wherein the registration request message and registration reply message are transmitted according to a MIP compatible communication protocol.

16. The network element of claim 15, wherein the QoS parameters are embedded within an extension field of the registration reply message compatible to the MIP compatible communication protocol.

17. The network element of claim 13, wherein the routing unit is configured to establish a communication session with the home agent of the home network, wherein the at least a portion of the QoS parameters are used specifically for the established communication session.

18. The network element of claim 13, wherein the QoS parameters comprise a parameter at least one of a traffic direction associated with a particular QoS parameter, rate, burst, and a DSCP value.

19. A computer-implemented method for routing network traffics, the method comprising:
receiving at a home agent of a home network a registration request message from a foreign agent of a foreign network in response to a mobile node entering the foreign network;
upon successfully validating the registration request, the home agent embedding quality of service (QoS) parameters in a registration reply message; and
the home agent transmitting the registration reply message to the foreign agent to enable the foreign agent to provision a communication session with the home agent on behalf of the mobile unit according to the QoS parameters.

20. The method of claim 19, wherein the mobile node and the home agent are Mobile IP (MIP) compliant devices, and wherein the registration request message and registration reply message are transmitted according to a MIP compatible communication protocol.

21. The method of claim 20, wherein the QoS parameters are embedded within an extension field of the registration reply message compatible to the MIP compatible communication protocol.

22. The method of claim 19, wherein the at least a portion of the QoS parameters are applied specifically to the communication session only.

23. A machine-readable medium having instruction stored therein, which when executed by a processor, cause the processor to perform a method for routing network traffics, the method comprising:
receiving at a home agent of a home network a registration request message from a foreign agent of a foreign network in response to a mobile node entering the foreign network;
upon successfully validating the registration request, the home agent embedding quality of service (QoS) parameters in a registration reply message; and
the home agent transmitting the registration reply message to the foreign agent to enable the foreign agent to provision a communication session with the home agent on behalf of the mobile unit according to the QoS parameters.
